(19) United States
(12) Patent Application Publication
(10) Pub. No.: US 2024/0320063 A1
(43) Pub. Date: Sep. 26, 2024

(54) INTEGRATION FROM LARGE LANGUAGE MACHINE-LEARNED MODEL POWERED APPLICATIONS TO ONLINE SYSTEM

(71) Applicant: Maplebear Inc., San Francisco, CA (US)

(72) Inventors: Haixun Wang, Bellevue, WA (US); Riddhima Sejpal, Dublin, CA (US)

(21) Appl. No.: 18/608,368

(22) Filed: Mar. 18, 2024

Related U.S. Application Data
(60) Provisional application No. 63/453,436, filed on Mar. 20, 2023.

(51) Int. Cl. G06F 9/54

(52) U.S. Cl. CPC G06F 9/541

(57) ABSTRACT

An online system receives, from a model serving system, an application programming interface (API) request from a plug-in provided by an online system. The API request includes a list of items obtained from a conversation session of a user with a machine-learned language model application of the model serving system. The online system generates a URL to a landing page for the user for creating a purchase list with the online system based on the list of items. Responsive to receiving a request to access the URL, the online system causes display of the landing page on a client device of the user that displays the purchase list including retailer items for one or more retailers corresponding to the list of items in the API request.

### CROSS-REFERENCE TO RELATED APPLICATIONS

This application claims the benefit of U.S. Provisional Patent Application No. 63/453,436, filed on Mar. 20, 2023, which is incorporated herein in its entirety.

### BACKGROUND

A user may interact with an application (e.g., web or mobile application), such as a chatbot application, that is powered by a large language model (LLM). Since the LLM is trained based on a significant large database including various sources of knowledge, the user can submit a prompt and obtain knowledge related to the prompt obtained from these sources. Often times, the user is also a user of an online system that provides one or more services to the user via an application of the online system that is separate from the LLM application. The user may wish to use information obtained from the LLM application to request services in the application of the online system. However, this is a time consuming and resource intensive process, and is prone to errors.

### SUMMARY

In accordance with one or more aspects of the disclosure, an online system receives, from a model serving system, an application programming interface (API) request from a plug-in provided by an online system. The API request includes a list of items obtained from a conversation session of a user with a machine-learned language model application of the model serving system. The online system generates a URL to a landing page for the user for creating a purchase list with the online system based on the list of items. The online system provides the URL to the landing page to the model serving system as a response to the API request for display to the user in the conversation session. Responsive to receiving a request to access the URL, the online system causes display of the landing page on a client device of the user. In one or more embodiments, the landing page displays the purchase list including retailer items for one or more retailers corresponding to the list of items in the API request, and a user interface (UI) element configured to allow the user to create an order with the retailer items.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates a block diagram of an architecture of the online system, in accordance with one or more embodiments.

FIG. 3A illustrates an example response from a model serving system and an example prompt to place an order, in accordance with one or more embodiments.

FIG. 3B illustrates an order generation request and response, in accordance with one or more embodiments.

FIG. 4 illustrates an example order page generated by the online system, in accordance with one or more embodiments.

FIG. 5 illustrates a flowchart describing a method of responding to an order generation request from a chatbot application, in accordance with one or more embodiments.

### DETAILED DESCRIPTION

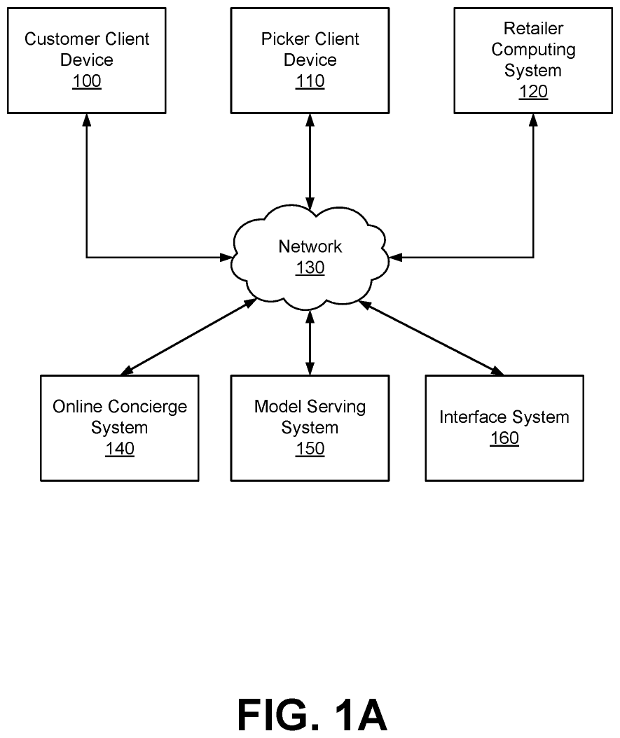

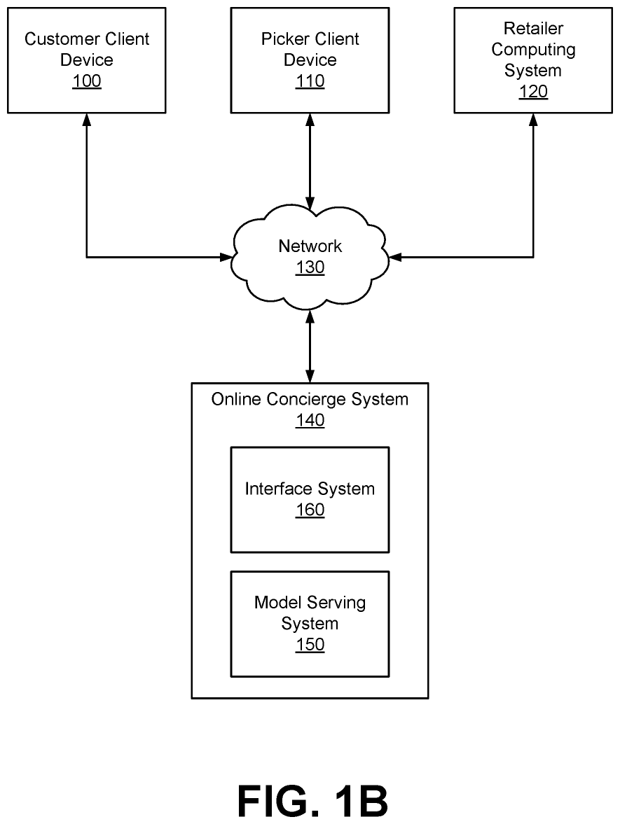

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to the delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via network 130. The network 130 is a collection of computing devices that communicate via wired or wireless connections. The network 130 may include one or more local area networks (LANs) or one or more wide area networks (WANs), and the like. The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may also use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects ordered items from a retailer location and delivers the ordered items to the customer. The online system 140 may charge a customer for the order and provides portions of the payment from the customer to the picker and the retailer.

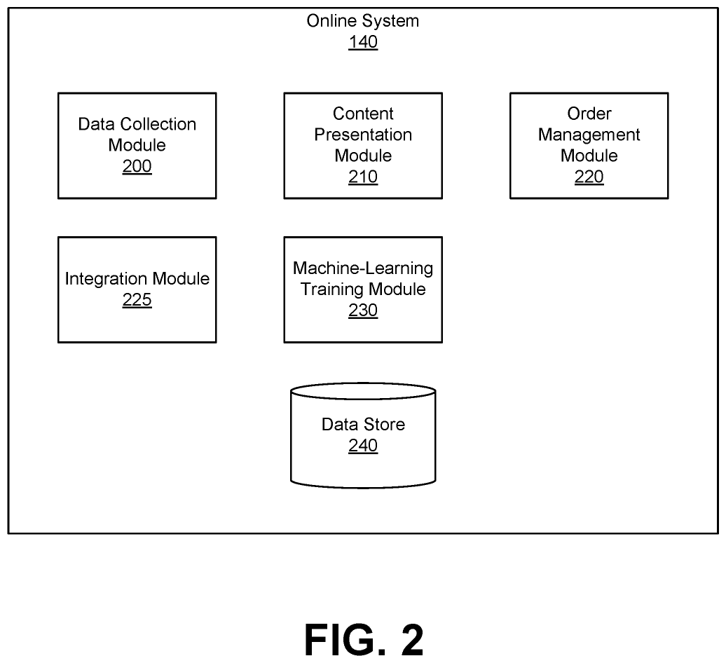

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using one or more machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or output data may be configured as any other number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

A user may interact with an application (e.g., web or mobile application), such as a chatbot application, deployed by the model serving system 150 and powered by a large language model (LLM). Since the LLM is trained based on a significant large training database including various sources of knowledge, the user can submit prompts and obtain knowledge related to the prompts from these sources during a conversation session. Often times, the user is also a user or a potential user of the online system 140. However, the online system 140 and the model serving system 150 may be managed by different entities and host a separate set of applications each having their own dedicated codebase, databases, API's, security boundaries, and therefore, have little or no connectivity with each other.

Often times, a user may wish to use the information obtained from the LLM application to request services in the application of the online system 140. For example, the user may prompt the LLM application “what is a recipe for lasagna?” and obtain as a response from the LLM, a list of ingredients and instructions for making the recipe. The user may then wish to order the list of ingredients from the retailer store using the online system 140. However, this is a manual and challenging process as the user has to search for the ingredients on the online system 140, map each ingredient to an actual item at a retailer store, determine whether the ingredients are available, and add the ingredients to the user's order. This process may require a significant amount of coordination and time by the user.

Thus, in one or more embodiments, the user can select to install a plug-in provided by the online system 140 on the model serving system 150. In one instance, the plug-in is a set of components including tools, local services, remote services, and the like that are provided to the model serving system 150 to provide one or more additional functionalities to the LLM application. In one example, the additional functionality is obtaining a list of items that are presented to the user during a conversation with the LLM application and generating a link to a landing page of the online system 140 that allows the user to order the items at a retailer store. That is, identifying an order opportunity during a conversation the LLM application and providing a link to the landing page.

Specifically, the user provides a prompt to the LLM application as a request and receives as a response a list of items. For example, an example question is “spaghetti and meatballs recipe” and the response from the LLM may be a list of ingredients and instructions for making the recipe. As another example, the question may be “what's an easy recipe for veggie stir-fry that I can make in less than 20 minutes?” and the response may be a list of ingredients and instructions for making the veggie stir-fry recipe. In one or more embodiments, using the plug-in, the model serving system 150 allows the user to proceed with converting the list of ingredients in the response to an order of the online system 140, such that the user can get the ingredients delivered without having to manually map the list of items to actual items at a retailer store. The user may place the order using the page or application, such that the ingredients can be delivered to the user. In this manner, a user can seamlessly and automatically order ingredients provided by the LLM in conjunction with the online system 140 without the need to manually search and include the ingredients if the user desires to fulfill a recipe.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

In one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. The context in the prompt may include portions of structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

As described above, responsive to a user of a model serving system 150 requesting to proceed with an order, the online system 140 receives the order generation request specifying a list of ingredients to include in the order. In one or more embodiments, since the list of ingredients received from the model serving system 150 may not include actual items that are commercially sold, the online system 140 maps and identifies an ingredient in the list to an actual item in a product catalog maintained by the online system 140. The catalog may store various types of information (e.g., price, quantity, calories, availability in stores, etc.) about each item. For a given user, the online system 140 may identify the location of the user, profile information about the user, and the like, and select stores in close proximity of the user that a picker can shop for the user. The online system 140 may map the ingredients to actual items that match the description or fall under similar or same product category, and are available at the identified store locations.

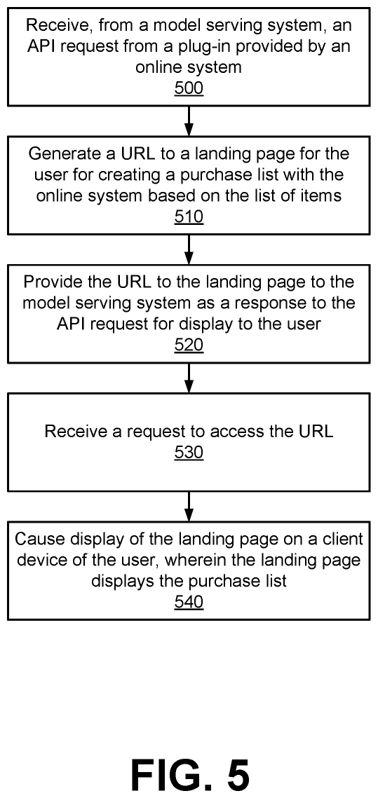

The online system 140 generates the order page including the list of ingredients, the items for each ingredient, an image of the items, as well as information like price for each item and an option to view alternatives to the particular item. As shown in FIG. 5, the order page may specify as a title the name of the recipe (“Spaghetti and Meatballs”) and present the list of identified items. In the example of FIG. 5, the black text under each item may specify the ingredient generated by the LLM as a response, the grey text under the black text may specify the name of the actual item identified by the online system 140. The online system 140 provides the URL to the model serving system 150, such that the URL link can be presented to the user. The user can access the order page and modify the list of items (e.g., add or delete or update) and add the items in the user's order by clicking a button, for example, the “Add 9 items to cart” button in FIG. 5.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates a block diagram of an example architecture for an online system 140, in accordance with one or more embodiments. The system architecture illustrated in FIG. 2 includes a data collection module 200, a content presentation module 210, an order management module 220, an integration module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In one or more embodiments, the data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. As an example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 obtains a list of key items for an order from the key item detection module 225. When the list of ordered items are presented to the picker client device 110 for fulfillment, the order management module 220 may generate indications that the identified items are key items in the order, such that the picker presented with the items can make an increased effort and/or spend more time to fulfill the key items. In one instance, the indication is a display mechanism that emphasizes the subset of identified key items on the list via, for example, bolded text, icons next to the items, and the like. In another instance, the indication is presentation of the list of items or at least the list of key items in the relative ordering of importance when specified from the key item detection module 225. Thus, the most important item may be presented first to the picker client device 110, and then the second most important item, and so on.

In yet another instance, the order management module 220 may apply additional logic or heuristics to the one or more key items to reflect items that are more business critical than others, for example, certain items that result in higher content-related revenue for the online system 140. For example, given a subset of key items for which one is a beverage of a particular brand, and another item is a food product, the order management module 220 may present the beverage of the particular brand at a higher order (e.g., higher position) on the list responsive to determining that the beverage of the particular brand is more business critical to the online system 140 than the food item.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a user may use a user client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

As described above, the integration module 225 configures a plug-in for the model serving system 150 that when installed by the user, allows the LLM application to identify order opportunities, and provide information on the order opportunities to the online system 140. The integration module 225 generates a link to a landing page that is provided to the user. When clicked, the user is directed to an order page of the online system 140 including a list of actual items that map to the list of items obtained from the conversation session shoppable at one or more retailer stores. In one or more embodiments, the plug-in exposes one or more API endpoints and is a set of remote services that are invoked when an order opportunity is identified during a conversation. For example, the API endpoint may retrieve information on a list of potential items that a user may need to fulfill their intent and return a URL to the landing page that when clicked by the user, displays the ordering page including a list of the actual items from one or more retailer stores.

The integration module 225 generates a manifest file for the plug-in that includes the name and the descriptions for the plug-in. As an example, the description for a plug-in for the online system 140 may be “I am a shopping assistant. If you have an intent of shopping for a grocery item or recipe, I can help you. I can also help if you have an intent of creating a shopping list for tasks.” The integration module 225 configures endpoints and operations such as GET or POST operations available for the endpoints. The integration module 225 generates an API specification that describes schema for invoking the API requests. In one instance, the manifest file and API specification are stored at a directory accessible by the model serving system 150. In one instance, the API specification follows an OpenAPI schema and may be generated using markup languages such as XML or JSON.

The integration module 225 may register the plug-in with the model serving system 150, such that users of the model serving system 150 can install the plug-in. One or more users of the model serving system 150 may install the plug-in and also perform required authentication, based on any authentication information described in the manifest file.

Responsive to the installation of the plug-in, the integration module 225 receives API requests invoked from a conversation session of a user with the model serving system 150. Specifically, based on the plug-in description (e.g., in the manifest file) and the descriptions and attributes of the API specification of the plug-in, the model serving system 150 identifies opportunities to invoke an API call during the conversation. In one instance, the descriptions for the plug-in, examples, description of endpoints provided by the integration module 225 are configured to detect an intent of making a recipe, completing a task, and the like, that can be fulfilled by ordering a list of items from the online system 140.

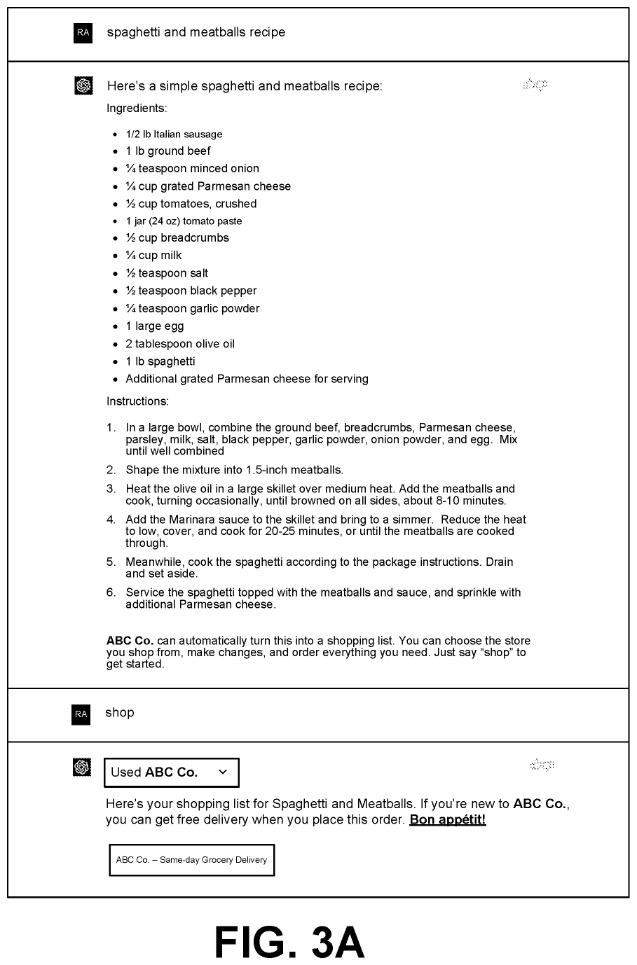

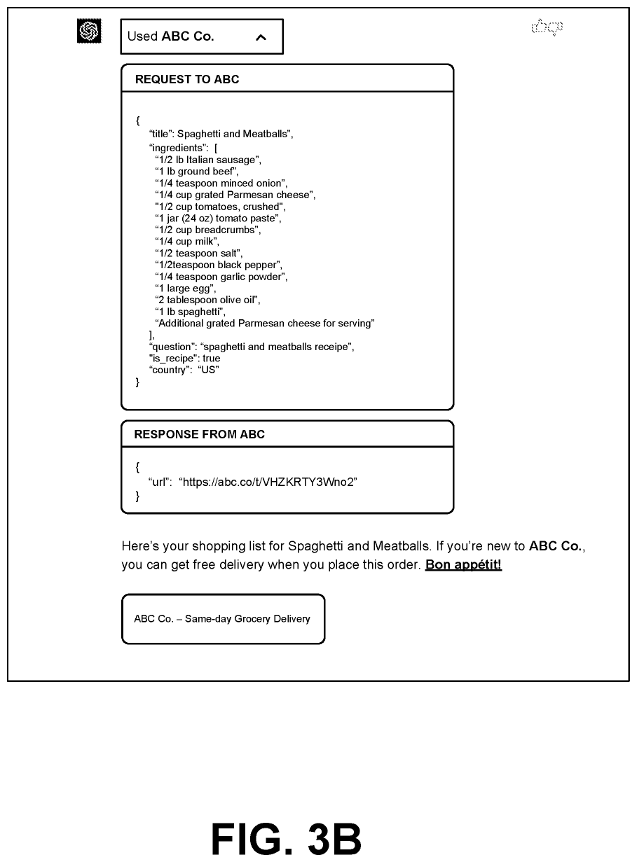

FIG. 3A illustrates an example screenshot of a conversation session with an LLM application, in accordance with one or more embodiments. As shown in FIG. 3A, the user of the LLM application provides a prompt “spaghetti and meatballs recipe.” Based on the plug-in description and the descriptions and attributes of the API specification of the plug-in, the LLM application may detect an order opportunity for the user, since the user's prompt reflects an intent to make a recipe and the descriptions provided by the integration module 225 match those intentions. The LLM application generates a response listing a set of ingredients and instructions for making the recipe. The LLM application also generates a response indicating that the user can use an application of the online system 140 to turn the list of ingredients into a shopping list and requesting a user to enter “shop” to get started. Thus, the user is prompted to enter a particular word in the chat window if the user would like to proceed with placing an order with the online system 140.

Responsive to the user submitting the prompt of “shop,” the integration module 225 receives an API request from the model serving system 150 that is invoked from the plug-in. In particular, the request may include a title of the request, a list of items, the original prompt of the order opportunity, a name of the entity managing the LLM application, a country of the request, and an indicator on whether the request is for a list of items for a recipe or whether the list of items is for a non-recipe shopping list. An example is described in detail below in conjunction with FIG. 3B. The LLM application or the plug-in formulates the request based on the schema of the API specification that specifies the inputs and the expected outputs for the endpoints.

In one or more embodiments, the request received by the integration module 225 follows a REST API communication protocol and may be formatted using JSON or XML. In one instance, the request is a GET API request, and the list of items extracted during the conversation session is included in the query parameters of the GET request. In another instance, the request is a POST API request, and the list of items extracted during the conversation and any instructions (e.g., instructions to make a recipe) are included in the body of the request. Since there is a limit to the number of characters that can be included in the query parameters of the GET request, receiving the request as a POST request allows the integration module 225 to receive more information compared to a GET request. In one or more embodiments, the request follows a remote procedure call (RPC) framework, such as gRPC.

The integration module 225 generates a URL for a landing page that when clicked by the user, directs the user to an order page that lists for at least one or more ingredients of the list, actual items corresponding to the ingredient and other data such as price, quantity, and the like of each item. In one instance, the order page is a page of a mobile application, a web page, a website, a web application, and the like. The integration module 225 provides the URL link to the model serving system 150 as a response to the request. The model serving system 150 can display the link and contextual information about the link to the user in the chat interface.

For example, as shown in FIG. 3A, the link is presented as a UI element with the label “ABC Co.—Same-day Grocery Delivery,” and a response to the user describing the link and offers provided by the online system 140. In addition, the model serving system 150 may also show the plug-in that was used to generate the link and attributes that were used to formulate the API request. For example, as shown in FIG. 3B, the user hovers over the UI element “Used ABC Co.” to view details of the request. For the spaghetti and meatballs recipe, the request was formulated based on the title of “Spaghetti and Meatballs,” the list of ingredients extracted from the response of the conversation, the original prompt by the user, and an indicator that indicates whether the list is for a recipe or a non-recipe shopping list. As yet another example, the user may submit a prompt “shopping list for camping trip,” and the request may be formulated based on:

```
{
  “Title”: “Camping Trip Essentials”,
  “ingredients”: [
    “pre-marinated meats”,
    “hot dogs and buns”,
    “burgers and buns”,
    “portable condiments”,
    “charcoal or propane” ],
  “instructions”: [ ],
  “question”: “Shopping list for camping trip”,
  “is_receipe”: false }.
```

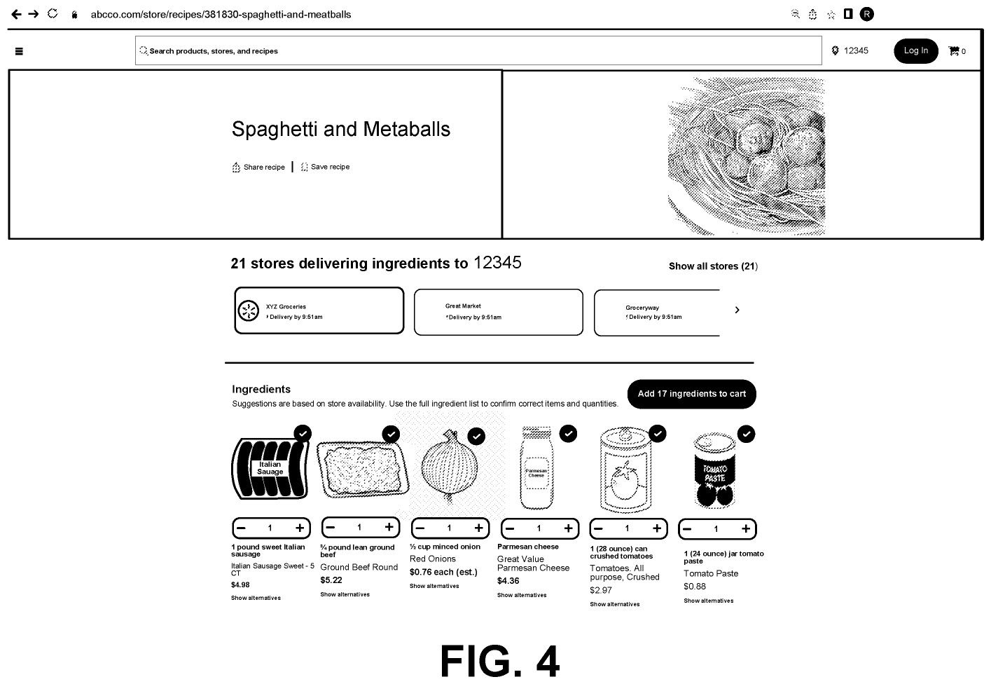

FIG. 4 illustrates an example landing page for a user, in accordance with one or more embodiments. In one or more embodiments, the link (when clicked by the user) renders a landing page that displays one or more retailer stores identified based on the location of the user (e.g., IP address). For each retailer, the online system 140 maps the items extracted from the conversation session to actual items for the retailer store to create a shopping list for the user. As an example, for the first retailer store, the landing page includes 17 items that are mapped to the list of ingredients in the request, including ground beef, breadcrumbs, Parmesan cheese, and marinara sauce. The user can then simply add the items to an order by clicking a UI element (e.g., “add 17 ingredients to cart”), such that the order can be fulfilled without the user manually searching and mapping the items from the conversation to items in the retailer store.

In one instance, when the list of items in the API request are “recipe” shopping lists, the online system 140 may generate a landing page that is classified as a recipe page. The recipe page includes a title of the recipe, an image of the recipe, and the list of ingredients. This way, the user as a user of the online system 140 may have a dedicated datastore to store favorite recipes of the user. The recipe page may have a UI element (e.g., “Save recipe” element in FIG. 4) that when clicked, allows the user to save the recipe page in the datastore. In another instance, when the list of items in the API request are “non-recipe” shopping lists, the online system 140 may generate a landing page that is classified as a shopping list page. The shopping list page includes a title of the shopping list, an image for the shopping list, and the list of items. However, it is appreciated that a list of items may be classified into any number of different categories that result in rendering of different types of landing pages for the user.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

FIG. 5 illustrates a flowchart describing a method of responding to an order generation request from a chatbot application, in accordance with one or more embodiments. The online system 140 receives 500, from a model serving system 140, an API request from a plug-in provided by an online system 140. The API request includes a list of items obtained from a conversation session of a user with a machine-learned language model application of the model serving system 150. The online system 140 generates 510 a URL to a landing page for the user for creating a purchase list with the online system 140 based on the list of items. The online system 140 provides 520 the URL to the landing page to the model serving system 150 as a response to the API request for display to the user in the conversation session. The online system 140 receives 530 a request to access the URL. The online system 140 causes 540 display of the landing page on a client device of the user. The landing page displays the purchase list including retailer items for one or more retailers corresponding to the list of items in the API request, and a user interface (UI) element configured to allow the user to create an order with the retailer items.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from a model serving system, an application programing interface (API) request from a plug-in provided by an online system, the API request including a list of items obtained from a conversation session of a user with a machine-learned language model application of the model serving system;
generating a URL to a landing page for the user for creating a purchase list with the online system based on the list of items;
providing the URL to the landing page to the model serving system as a response to the API request for display to the user in the conversation session; and
responsive to receiving a request to access the URL, causing display of the landing page on a client device of the user, wherein the landing page displays the purchase list including retailer items for one or more retailers corresponding to the list of items in the API request, and a user interface (UI) element configured to allow the user to create an order with the retailer items.

2. The method of claim 1, further comprising:
generating one or more endpoints for receiving one or more API requests from the model serving system;
generating an API specification defining the one or more API requests, wherein the API specification is formatted in JSON or XML; and
registering the plug-in with the model serving system by providing access to the one or more endpoints and the API specification.

3. The method of claim 2, further comprising:
generating a manifest file describing one or more functionalities of the plug-in in a natural language format; and
providing access to the manifest file to the model serving system.

4. The method of claim 1, wherein the API request specifies that the list of items is for fulfilling a recipe, and the landing page is a recipe page additionally displaying a title of the recipe and an image representing the recipe.

5. The method of claim 1, wherein the API request specifies that the list of items is for fulfilling a task that is not a recipe, and the landing page is a shopping list page additionally displaying a title of the shopping list and an image representing the shopping list.

6. The method of claim 1, wherein causing display of the landing page on the client device comprises:
determining a geographic location of the user, and wherein the one or more retailers are identified based on the determined location.

7. The method of claim 1, wherein the API request is received as a POST request, and a body of the POST request includes the list of items and one or more instructions for using the list of items.

8. A non-transitory computer readable storage medium comprising stored program code instructions, the instructions when executed causes a processing system to:
receive, from a model serving system, an application programing interface (API) request from a plug-in provided by an online system, the API request including a list of items obtained from a conversation session of a user with a machine-learned language model application of the model serving system;
generate a URL to a landing page for the user for creating a purchase list with the online system based on the list of items;
provide the URL to the landing page to the model serving system as a response to the API request for display to the user in the conversation session; and
receive a request to access the URL; and
cause display of the landing page on a client device of the user, wherein the landing page displays the purchase list including retailer items for one or more retailers corresponding to the list of items in the API request, and a user interface (UI) element configured to allow the user to create an order with the retailer items.

9. The non-transitory computer readable storage medium of claim 8, the instructions when executed further causes the processing system to:
generate one or more endpoints for receiving one or more API requests from the model serving system;
generate an API specification defining the one or more API requests, wherein the API specification is formatted in JSON or XML; and
register the plug-in with the model serving system by providing access to the one or more endpoints and the API specification.

10. The non-transitory computer readable storage medium of claim 9, the instructions when executed further causes the processing system to:
generate a manifest file describing one or more functionalities of the plug-in in a natural language format; and
provide access to the manifest file to the model serving system.

11. The non-transitory computer readable storage medium of claim 8, wherein the API request specifies that the list of items is for fulfilling a recipe, and the landing page is a recipe page additionally displaying a title of the recipe and an image representing the recipe.

12. The non-transitory computer readable storage medium of claim 8, wherein the API request specifies that the list of items is for fulfilling a task that is not a recipe, and the landing page is a shopping list page additionally displaying a title of the shopping list and an image representing the shopping list.

13. The non-transitory computer readable storage medium of claim 8, wherein instructions to cause display of the landing page on the client device comprises instructions when executed further causes the processing system to:
determine a geographic location of the user, and wherein the one or more retailers are identified based on the determined location.

14. The non-transitory computer readable storage medium of claim 8, wherein the API request is received as a POST request, and a body of the POST request includes the list of items and one or more instructions for using the list of items.

15. A computer system comprising:
a processor; and
a non-transitory computer-readable medium storing instructions that, when executed by the processor, cause the processor to:
receive, from a model serving system, an application programing interface (API) request from a plug-in provided by an online system, the API request including a list of items obtained from a conversation session of a user with a machine-learned language model application of the model serving system;
generate a URL to a landing page for the user for creating a purchase list with the online system based on the list of items;
provide the URL to the landing page to the model serving system as a response to the API request for display to the user in the conversation session; and
receive a request to access the URL; and
cause display of the landing page on a client device of the user, wherein the landing page displays the purchase list including retailer items for one or more retailers corresponding to the list of items in the API request, and a user interface (UI) element configured to allow the user to create an order with the retailer items.

16. The computer system of claim 15, the instructions when executed further causes the processor to:
generate one or more endpoints for receiving one or more API requests from the model serving system;
generate an API specification defining the one or more API requests, wherein the API specification is formatted in JSON or XML; and
register the plug-in with the model serving system by providing access to the one or more endpoints and the API specification.

17. The computer system of claim 16, the instructions when executed further causes the processor to:
generate a manifest file describing one or more functionalities of the plug-in in a natural language format; and
provide access to the manifest file to the model serving system.

18. The computer system of claim 15, wherein the API request specifies that the list of items is for fulfilling a recipe, and the landing page is a recipe page additionally displaying a title of the recipe and an image representing the recipe.

19. The computer system of claim 15, wherein the API request specifies that the list of items is for fulfilling a task that is not a recipe, and the landing page is a shopping list page additionally displaying a title of the shopping list and an image representing the shopping list.

20. The computer system of claim 15, wherein instructions to cause display of the landing page on the client device comprises instructions when executed further causes the processor to:
determine a geographic location of the user, and wherein the one or more retailers are identified based on the determined location.
